(19) United States
(12) Patent Application Publication
(10) Pub. No.: US 2003/0177597 A1
(43) Pub. Date: Sep. 25, 2003

(54) Roller and paintbrush cleaning kit

(76) Inventor: Millard F. Wallace III, Oaks, PA (US)

Correspondence Address: WILLIAM J. MASON, MACCORD MASON PLLC, POST OFFICE BOX 1489, WRIGHTSVILLE BEACH, NC, 28480, US

(21) Appl. No.: 10/370,899

(22) Filed: Feb. 20, 2003

Related U.S. Application Data
(60) Provisional application No. 60/359,211, filed on Feb. 21, 2002.

(51) Int. Cl. B05C 21/00; A46B 17/06

(52) U.S. Cl. 15/142; 15/236.03; 134/138; 134/900

(57) ABSTRACT

A kit for use in cleaning paintbrushes and paint rollers includes a paintbrush cleaning tool having a hollow, elongated handle, a closed proximal end, an open distal end adapted for attachment of a hose, and a plurality of teeth extending transversely from the handle adjacent the handle distal end, the teeth having base ends attached to the handle and outer ends, and holes at the base of the teeth extending into the interior of the handle; and a paint roller cleaning tool having a tubular section with a hollow interior, a closed lower end, an open upper end adapted for attachment of a hose, a plurality of spaced, longitudinally aligned holes in communication with the hollow interior, and a clip extending outwardly from the tubular section. The kit can also include a container, such as a bucket, and a hose, with the tools and hose being stored in the container.

This application claims the benefit of Provisional Application Serial No. 60/359,211, filed Feb. 21, 2002.

### BACKGROUND OF THE INVENTION

(1) Field of the Invention

The present invention relates to an apparatus for cleaning paint from paint rollers and paintbrushes, and in particular to a roller and paintbrush cleaning kit that can be easily manufactured and compactly packaged for retail sale. The invention also relates to the individual tools used to clean rollers and paintbrushes.

(2) Description of the Prior Art

Heretofore, removal of paint, especially latex paint, from paint rollers or paintbrushes has usually been performed by placing the roller or brush under a faucet and massaging the roller or brush with the fingers. This procedure, in addition to being messy and time consuming, normally leaves some of the paint in the roller or brush. Devices have been purposed in which the roller or brush is placed in housing and cleaned by pumping water through the housing. Designs so far purposed have met with little commercial acceptance.

Thus, there is a need for simple, mess-free, efficient and economical devices for cleaning paint from paint rollers and paint brushes. In addition, there is a need for a kit that includes such tools that can be compactly stored and displayed for retail sale.

### SUMMARY OF THE INVENTION

This need is addressed by the present invention, which is comprised of paint roller cleaner and paintbrush cleaner tools that are attachable to a source of water, such as a faucet or spigot. The kit that includes these tools may further include a bucket or other container, and a hose to connect the tools to the water source.

The paintbrush cleaning tool is in the form of a comb-like apparatus having a hollow handle with a proximal end that is connectable to a hose, and a plurality of outwardly projecting teeth that can be drawn through the brush bristles. A plurality of holes are positioned in the handle in line with, and preferably adjacent to, the base of the teeth to project jets of water generally along the axis of the teeth, and thereby contact paint within the brush while the teeth are drawn through the brush bristles. Preferably, the tool teeth extend transversely from the axis of the paintbrush cleaner tool handle. The paint brush cleaning tool may also include a paint roller scraper in the configuration of a blade with a semi-circular cut-out section, that can be drawn along a roller to remove excess paint prior to cleaning with the paint roller cleaning tool.

The paint roller cleaning tool is comprised of a tubular member having a proximal end connectable to a hose, and a closed distal end. An attachment clip is at the proximal end of the tubular member for use in attaching the roller cleaning tool to a container. This clip may also be used as a handle, it being understood that the term “clip” as used herein is intended to define an arm with a proximal end attached to the tool and a free distal end that is useful as an attachment clip and/or as a handle. The clip may extend downward and/or outwardly and, in some configurations may extend upwardly. A series of spaced holes are axially aligned along the tubular member, with the radius of the holes preferably being at an angle, e.g., of approximately 180° to 270°, measured clockwise, relative to the clip. Thus, water directed into the interior of the tubular member exits through the holes as a pressurized curtain of water. Preferably, the water curtain is angled downwardly, e.g., at an angle of about 0° to 20°, preferably about 15°.

The above tools may be hand-held during use. Preferably, however, the paint roller and paintbrush cleaning tools are conveniently used with a container that collects the water, and also holds the paint roller tool during use. This container, which may be a conventional 5 gallon bucket, preferably has a depth greater than the roller to be cleaned, and preferably a diameter at the bottom of the bucket greater than the lengths of the tools. Other containers, such as a utility sink, trash can, etc., can also be used. The container may also include a handle that can be positioned to support the container at an angle during use, allowing the tainted water to be discharged from the container. Alternatively, the container can be used in an upright position and turned upside down to empty. The container may also have a hole with a removable cap in the bottom to drain water. The preferred containers are buckets of the type that are stackable, one within the other for shipment and retail display, with a space of about 4 inches between the outer surface of the bottom of one bucket and the inner surface of the bottom of the immediately lower bucket.

A hose may also be provided to attach each of the tools to a faucet or spigot. Generally, the hose will be a rubber or plastic hose having a fitting at one end adapted for attachment to a faucet or spigot, and the fitting at the other end being adapted for attachment to the paintbrush and paint roller tools. In a preferred embodiment, the fittings at both ends are female fittings. It will be understood, however, that one of the fittings may instead by male fittings, such as on a garden hose, or both may be male fittings, depending on the design of the tool attachment ends. The hose may also include a handle or grip to facilitate its use when the tools are used as hand-held tools.

When shipped and displayed, or for storage, the hose can be rolled up and inserted into the bottom of the bucket along with the tools. The rolled hose and tools should fit within the “dead” space between the stacked buckets, so that the kits can be compactly displayed in the retail establishment. The tools can also be sold without a bucket for use with the purchaser's own container. The tools can also be sold with or without the hose.

Thus, it is an objective of the present invention to provide a paintbrush cleaning tool having an elongated handle with a hollow interior, a closed proximal end, an open distal end adapted for attachment of a hose, a plurality of teeth extending transversely from the handle adjacent the distal end, the teeth having base ends attached to the handle and outer ends, and holes at the base of the teeth extending into the interior of the handle, whereby water is capable of flowing from the handle proximal end through the hollow interior and from the holes along the teeth.

It is a further objective of the invention to provide a paint roller cleaning tool having a tubular section with a hollow interior, a closed lower end and an open upper end adapted for attachment of a hose, the section including a plurality of spaced, longitudinally aligned holes in communication with the hollow interior, whereby water is capable of flowing from the tubular section upper end through the hollow interior for discharge through the holes, and an attachment clip extending outwardly from the tubular section.

It is another objective of the invention to provide a kit for use in cleaning paintbrushes and paint rollers that includes the above paintbrush cleaning tool and paint roller cleaning tool, and optionally a bucket or other container and a hose, the two tools and the hose being storable for shipment and display within the bucket.

Other objectives of the invention will become apparent to one skilled in the art upon reading the following detailed description of the invention, taken with the drawings.

### BRIEF DESCRIPTION OF THE DRAWINGS

FIG. 1 is a side view of the paintbrush cleaning tool.

FIG. 2 is a frontal view of the paintbrush cleaning tool.

FIG. 3 is a rear view of the paint roller cleaning tool.

FIG. 4 is a side view of the paint roller cleaning tool.

FIG. 5 is a top view of the paint roller cleaning tool positioned in a bucket.

FIG. 6 is a hose with female fittings at each end.

FIG. 7 is a sectional side view of a kit with the tools and hose stored in the bottom of a stacked bucket.

FIG. 8 is a perspective view of the paint roller cleaning system positioned for use.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

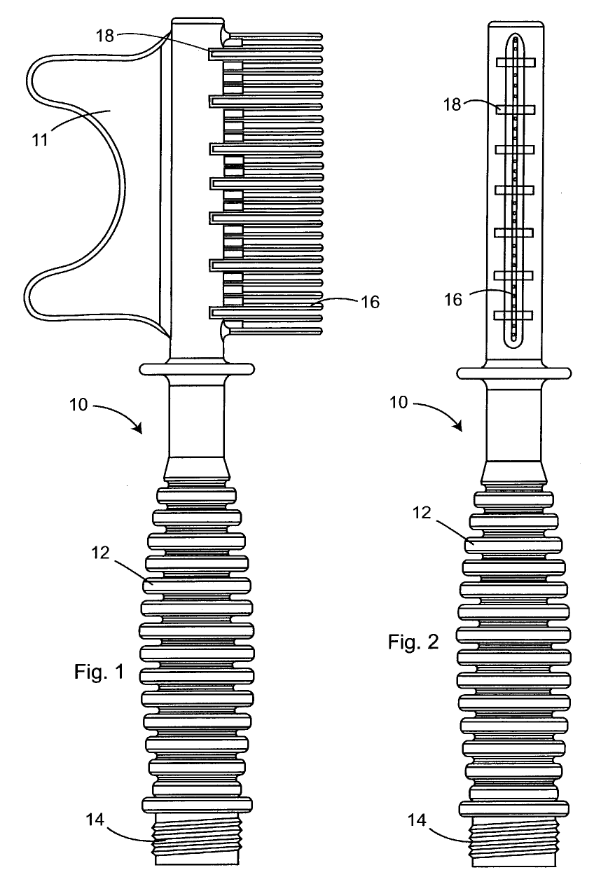

As best illustrated in FIGS. 1 and 2, paintbrush cleaning tool, generally 10, is comprised of hollow handle 12 having a hose connection 14 at its proximal end, and a plurality of parallel teeth 16 extending transversely from the distal end on handle 12. Handle 12 includes a plurality of holes 18 inline with and adjacent to the base of teeth 16. A paint roller scraper 11 comprised of a blade with a cut-out section having a diameter slightly greater than a paint roller extends outwardly from the opposite side of handle 12 for use in scraping excess paint from rollers prior to cleaning.

When used, a hose 20, shown in FIG. 6, is connected to connection 14 and water flows through the interior of handle 12 and at increased pressure through holes 18 along pathways generally parallel to or inline with teeth 16. Teeth 16 are combed through the bristles of the brush to be cleaned, so that the jets of water from holes 18 deeply clean between the bristles.

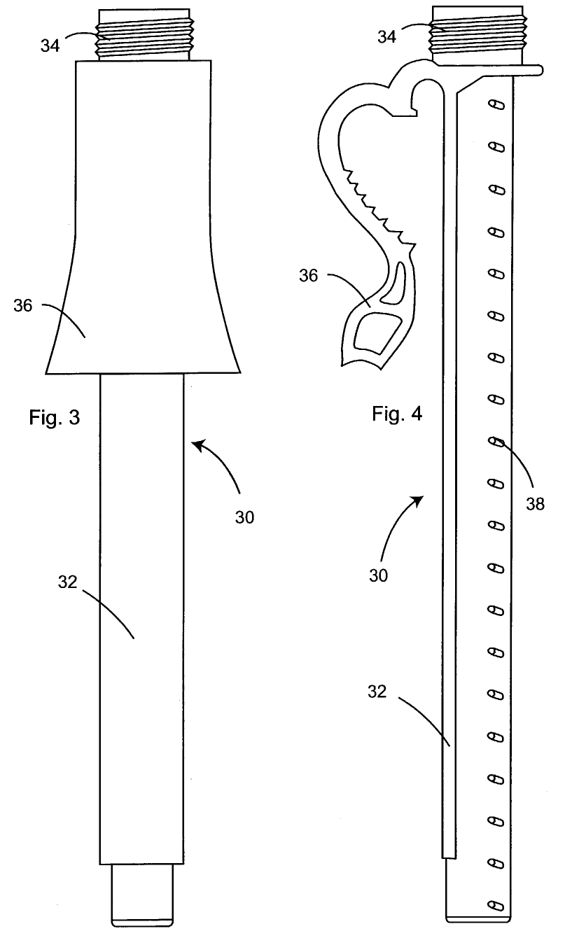

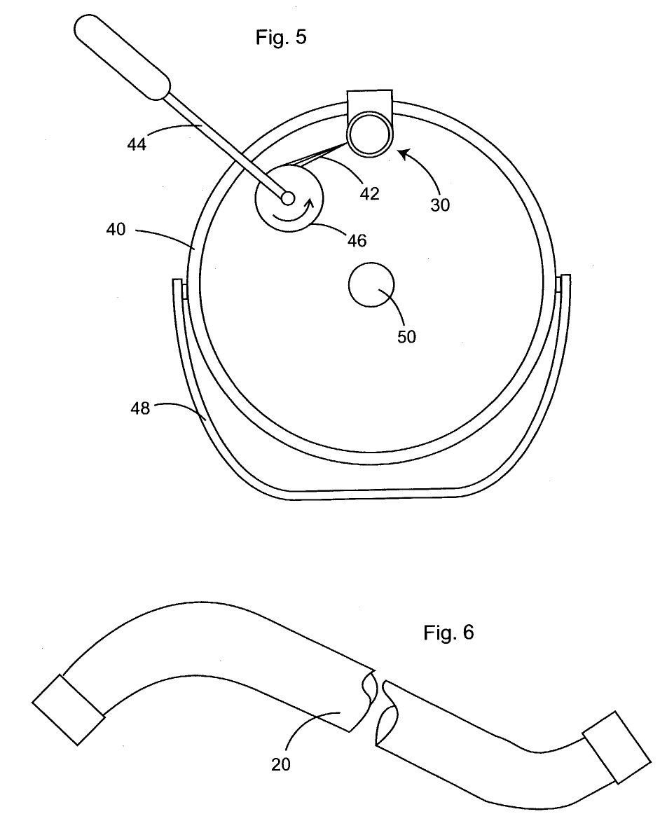

As illustrated in FIGS. 3 and 4, paint roller cleaning tool, generally 30 is comprised of a tubular wand 32 having a hose connection 34 at its proximal end, and a closed distal end. Clip 36 is integrally molded at the proximal end of tubular wand 32. Wand 32 includes a plurality of spaced holes 38 axially aligned along wand 32 with the radius of the holes preferably being at an angle relative to clip 36. When in use, as illustrated in FIG. 5, wand 32 is inserted into bucket 40, and held in place with clip 36. Hose 20 is connected to connection 34 and to a water source. Water flows through wand 32 and exits through holes 38 to form a pressurized water curtain 42. A paint roller handle 44 is laid over the side of bucket 40 so that the paint roller 46 is positioned so that water curtain 42 impacts generally tangentially against roller 46, preferably on the side of the roller adjacent the inner wall of bucket 40, causing roller 46 to spin, exposing all parts of the roller to curtain 42. This centrifugal force resulting from the spinning, in conjunction with the force of the water curtain, forces the paint off of the roller nap.

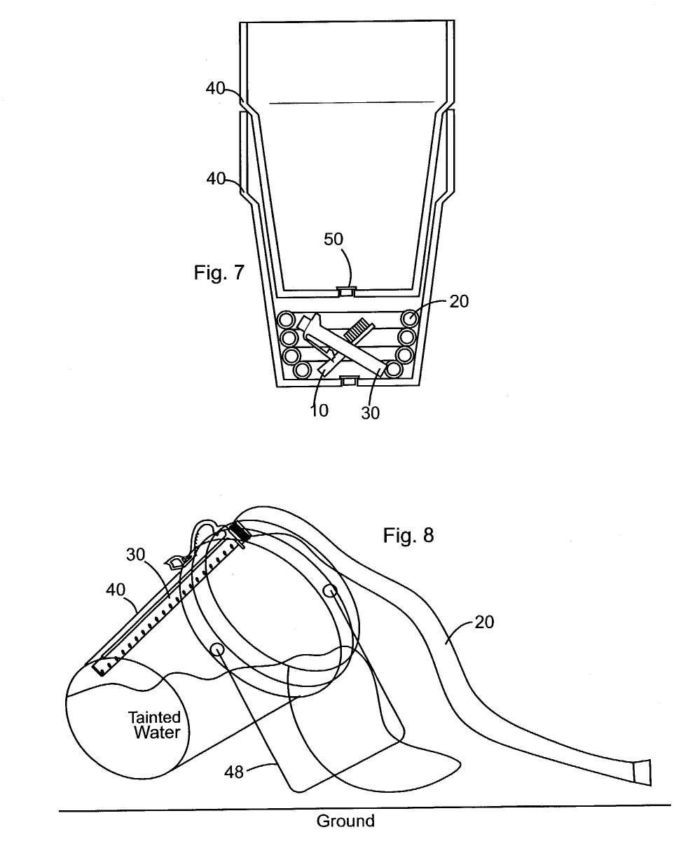

As illustrated in FIG. 7, tools 10 and 30, and hose 20, can be conveniently housed in the bottom of bucket 40. When shipped or displayed, or stored, buckets 40 can be stacked as shown. FIG. 8 illustrates paint roller cleaning tool 30 mounted in bucket 40, which is supported at an angle on bucket handle 48. In this position, tainted water can overflow from bucket 40 during cleaning of the paint roller. Tainted water must discharge from bucket 40 to allow roller 46 to continue to spin for the cleaning process. Alternatively, bucket 40 can be used in the upright position and turned upside down after use to pour out the tainted water, or capped drain hole 50 can be opened to drain the water.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A paintbrush cleaning tool comprising:
a) an elongated handle having a hollow interior, a closed proximal end and an open distal end adapted for attachment of a hose; and
b) a plurality of teeth extending transversely from said handle adjacent said distal end, the teeth having base ends attached to the handle and outer ends, and holes at the base of the teeth extending into the interior of said handle.

2. The tool of claim 1, wherein said teeth are spaced equidistantly in a common plane.

3. The tool of claim 1, wherein said handle includes a longitudinal axis and said teeth are radially aligned with said longitudinal axis.

4. The tool of claim 1, further including a plate having an inner edge attached to said handle and an outer edge including a semi-circular cut-out section having a given radius for use in cleaning paint rollers having a radius corresponding to said given radius.

5. The tool of claim 4, wherein said teeth and said plate extend from opposite sides of said handle.

6. A paint roller cleaning tool comprising:
a) a tubular section having a hollow interior, a closed lower end and an open upper end adapted for attachment of a hose, said section including a plurality of spaced, longitudinally aligned holes in communication with said hollow interior, whereby water is capable of flowing from said tubular section upper end through said hollow interior for discharge through said holes; and
b) a clip extending outwardly from said tubular section.

7. The tool of claim 6, wherein each of said holes are positioned at an angle of from about 180° to about 270° relative to said clip.

8. The tool of claim 6, wherein the axes of said holes projects downwardly at an angle of from about 0° to about 20°.

9. A kit for use in cleaning paintbrushes and paint rollers comprising:
a) a paintbrush cleaning tool having an elongated handle with a hollow interior, a closed proximal end, an open distal end adapted for attachment of a hose, and a plurality of teeth extending transversely from said handle adjacent said distal end, the teeth having base ends attached to the handle and outer ends, and holes at the base of the teeth extending into the interior of said handle, whereby water is capable of flowing from said handle proximal end through said hollow interior and said holes for discharge along said teeth; and
b) a paint roller cleaning tool having a tubular section with a hollow interior, a closed lower end, an open upper end adapted for attachment of a hose, a plurality of spaced, longitudinally aligned holes in communication with said hollow interior, and a clip extending outwardly from said tubular section, whereby water is capable of flowing from said tubular section upper end through said hollow interior for discharge through said holes.

10. The kit of claim 9, wherein said paintbrush cleaning tool teeth are spaced equidistantly in a common plane.

11. The kit of claim 9, wherein said paintbrush cleaning tool handle includes a longitudinal axis and said teeth are radially aligned with said longitudinal axis.

12. The kit of claim 9, wherein said paintbrush cleaning tool further includes a plate having an inner edge attached to said handle and an outer edge including a semi-circular cut-out section having a given radius for use in cleaning paint rollers having a radius corresponding to said given radius.

13. The kit of claim 12, wherein said paintbrush cleaning tool teeth and said plate extend from opposite sides of said handle.

14. The kit of claim 9, wherein said paint roller cleaning tool holes are positioned at an angle of from about 180° to about 270° relative to said clip.

15. The kit of claim 9, wherein the axes of said paint roller cleaning tool holes project downwardly at an angle of from about 0° to about 20°.

16. The kit of claim 9, further including a container.

17. The kit of claim 9, further including a hose.

18. The kit of claim 9, further including a bucket and a hose, said hose, said paintbrush cleaning tool, and said paint roller cleaning tool being stored inside said bucket.

19. The kit of claim 16, wherein said container is a stackable bucket having a bottom with an interior surface and an exterior surface, whereby a space is provided between the interior surface of the bottom of a first bucket and the exterior surface of the bottom of a second bucket when said first and second buckets are stacked, said hose, said paintbrush cleaning tool, and said paint roller cleaning tool being storable within said space.

20. The kit of claim 19, wherein said bucket includes a handle adapted to support said bucket at an angle on a surface during roller cleaning.
